(19) United States
(12) Patent Application Publication
(10) Pub. No.: US 2014/0001069 A1
(43) Pub. Date: Jan. 2, 2014

(54) Reversible cases for concealing alternative nutrition and/or intravenous bags hanging from an IV stand pole

(71) Applicant: Dovie Gilmore, Milwaukee, WI (US)

(72) Inventor: Dovie Gilmore, Milwaukee, WI (US)

(73) Assignee: Dovie Gilmore, Milwaukee, WI (US)

(21) Appl. No.: 13/987,714

(22) Filed: Aug. 26, 2013

Related U.S. Application Data
(63) Continuation-in-part of application No. 13/066,691, filed on Apr. 22, 2011.

(51) Int. Cl. A61J 1/16

(52) U.S. Cl. CPC A61J 1/16
USPC 206/438

(57) ABSTRACT

The present is an alternative nutrition and/or intravenous bag concealing sack fabricated from a series of fabric, plastic and/or paper components, a zipper, Velcro or snaps providing a means of easy access to the bags and an elastic band, positioned in the bottom seam of the sack, providing a means which permit the sack free movement horizontally in and out covering adjacent surfaces.

### CROSS REFERENCE TO RELATED APPLICATION

The patent application is a continuation-in-part of patent application Ser. No. 13/066,691 filed on Apr. 22, 2011 and therefore make a basis for claim to priority of the current patent application under 35 USC 119 (a)-(d).

I claim priority to provisional application No. 61/342,673 “Cloth sewn cases of concealing alternative nutrition and/or intravenous bags hanging from a stand pole”, filed Apr. 19, 2010.

### BACKGROUND OF THE INVENTION

1.) The field of the present invention relates to a firm fitted form of a pillowcase for use of concealing alternative nutrition and/or intravenous bags. The concept of a reversible soft fabric, plastic or paper cover, with a zipper, Velcro or snap front, for concealing alternative nutrition and/or intravenous as to provide privacy for individual recipients.

2.) The prior art conventional pillowcases for pillows, such as U.S. Pat. No. 5,084,928 are described as formed of one or more sheets of soft, flexible fabric such as cotton either woven in a tubular shape or as a flat sheet of material.

### SUMMARY OF THE INVENTION

The alternative nutrition and/or intravenous bag concealing sack provides a fabric, plastic and/or paper provision of a pillowcase designed to facilitate disclosure of alternative nutrition and/or intravenous bags hanging from an intravenous stand pole. The concealing sacks vertical movement and the free horizontal movement of the elastic band sewn into the bottom of the sack provides disclosure of multiple adjacent surfaces. The zipper, snaps or Velcro purpose an easy access to the alternative nutrition/intravenous bags. The fabric, plastic and/or paper of different prints provides reversibility, of the sack.

### DESCRIPTION OF THE DRAWINGS

FIG. 1 is a perspective view of the concealing sack 200 as seen in FIG. 8b and covering intravenous bag 300 and pole 100.

FIG. 2 is a plan view of the sack fabric pattern pieces 111, 112, 113, and 114 before they are stitched.

FIG. 3a is a plan view of the top sack fabric pattern pieces 115 and 116, being different prints, before they are stitched.

FIG. 3b is a perspective view of the Velcro, zipper, or snaps 117 that stitches at the open ends of 113, 114, 119, and 121 and an elastic band 118.

FIG. 4a is a plan view of the sack fabric pattern pieces 119 and 121 before they are stitched.

FIG. 4b is a view of the sack pattern pieces of different prints for reversibility two front left sides sewn or

glued together 122 as seen in FIGS. 5, 6a and 8b.

FIG. 5 is a plan view of the sack pattern pieces of different prints for reversibility two back 123, two left sides 122, two right sides pieces 124 sewn or glued together and a zipper, Velcro, or snaps as seen in FIG. 3b.

FIG. 6a is a view of the sack pattern pieces fronts back top pieces and zipper, Velcro, or snaps sewn or glued together 125.

FIG. 6b is a bottom and elevated view of sack showing empty cavity 126 stitches 127 and elastic band 118 with a separation 128.

FIG. 7 is a view showing seam 240 corresponding with FIG. 8b.

FIG. 8a is a top view showing the top sewn, view sack 129 showing seam 131.

FIG. 8b is a front view 132 corresponding with FIG. 1 shows elastic band 118 stitched 134 to bottom seam of sack horizontally and zipper, Velcro or snaps 117 stitched 135 to bottom seam of sack vertically.

### DETAILED DESCRIPTION OF THE INVENTION

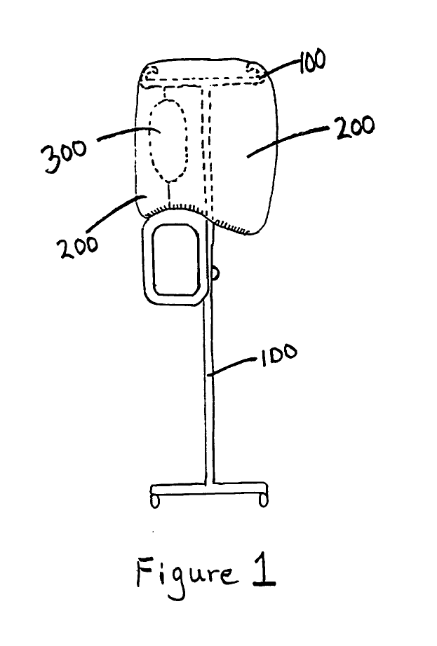

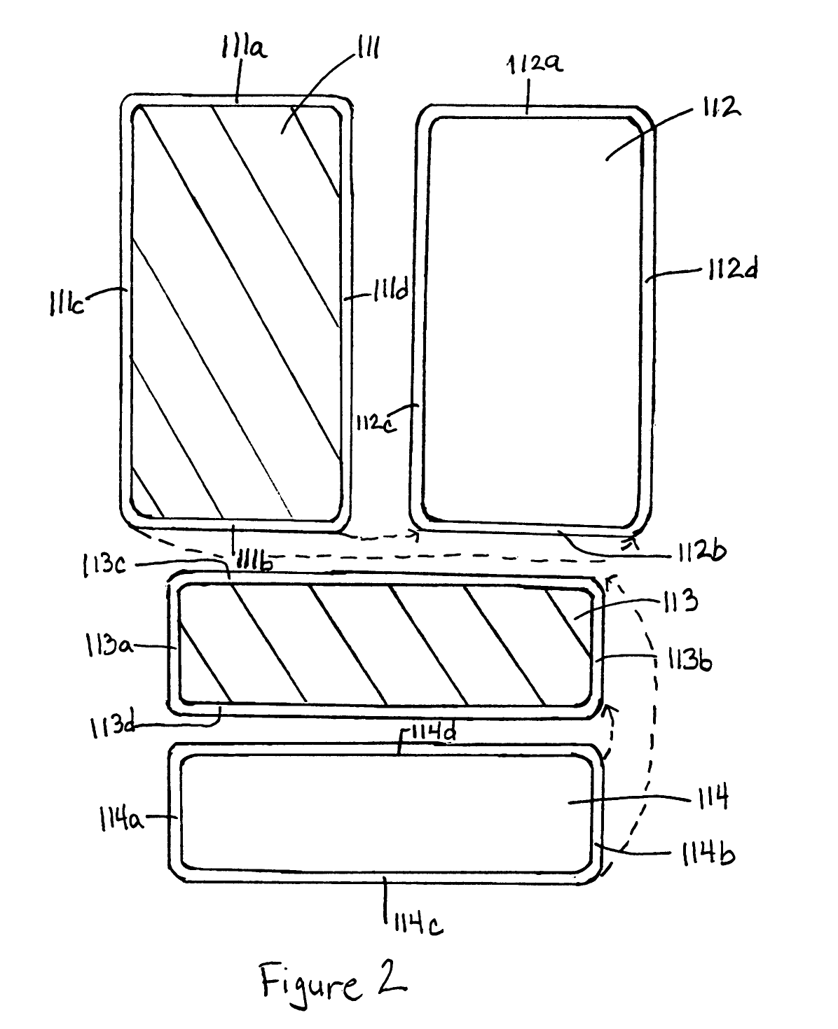

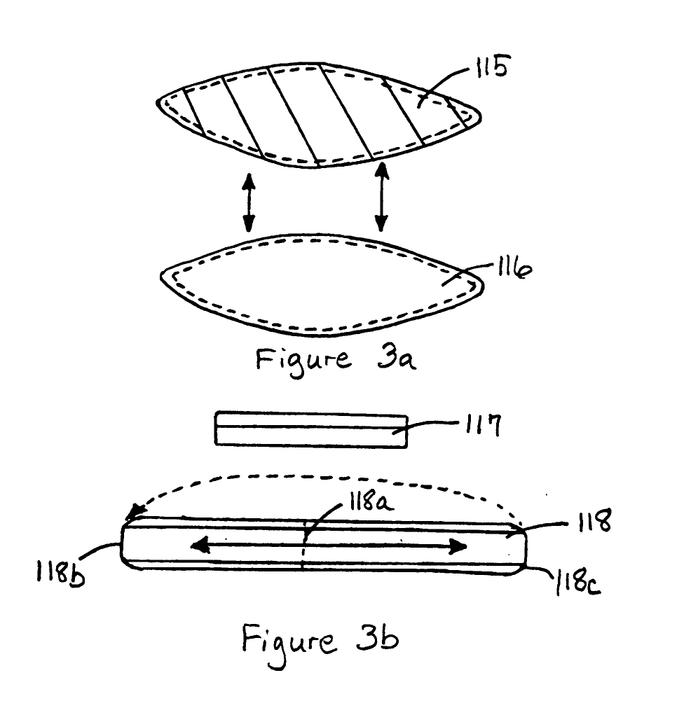

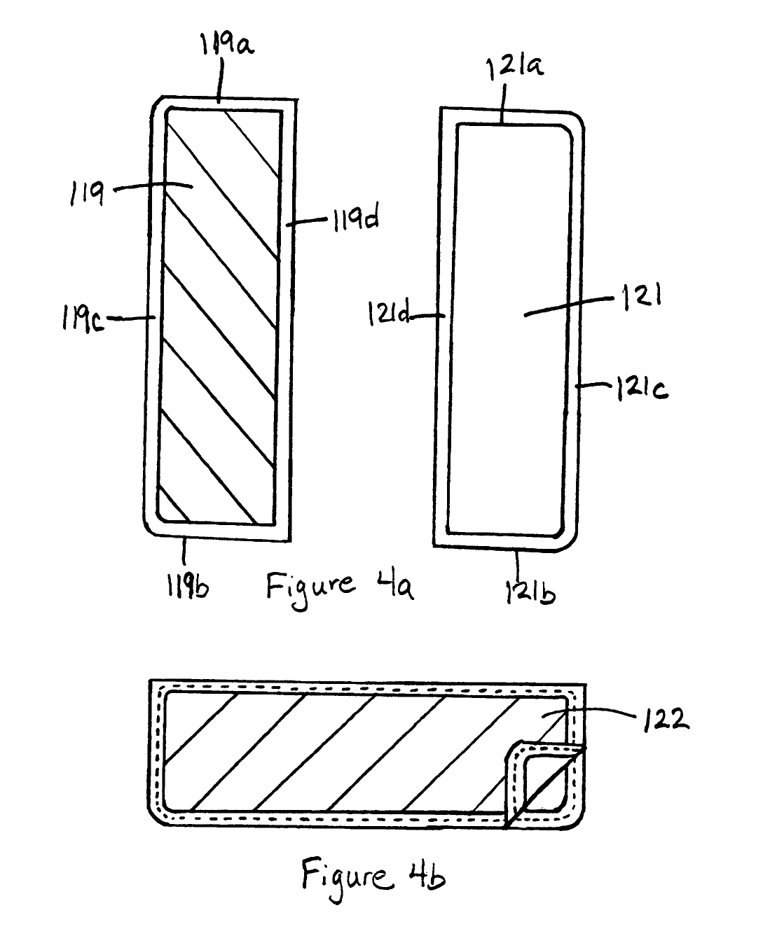

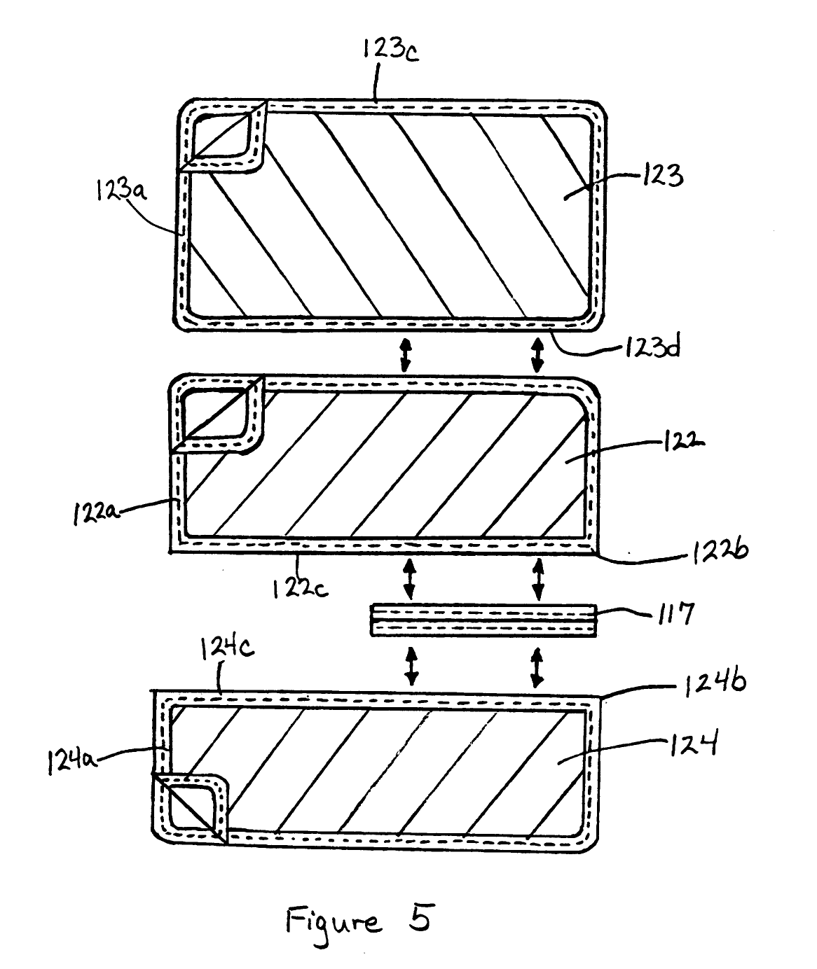

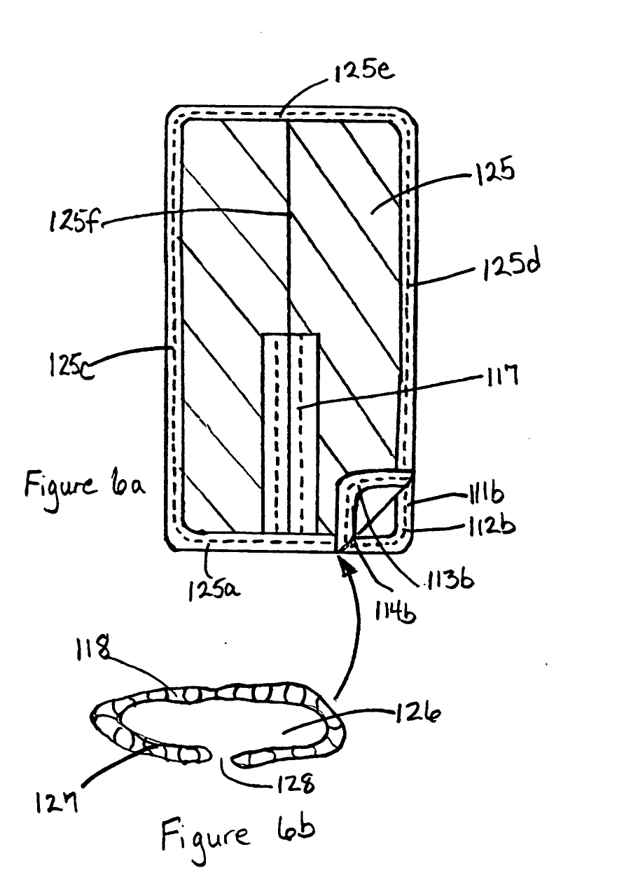

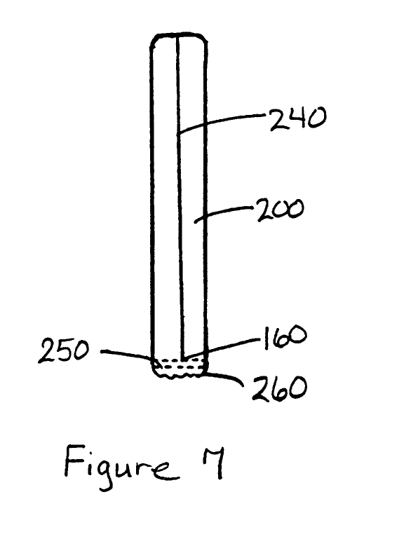

Referring to drawings FIGS. 2, 3a, 3b, 4a, 4b, 5, 6a, 6b, 7, 8a, 8b and firstly FIG. 1, shows an exemplary embodiment sack 200 formed of cloth fabric, plastic or paper concealing the top portion of an intravenous pole 100 and bag 300 hanging from the pole. The peripheral extremities of the rectangular fabric pattern pieces 111, 112, 113, 114, 119, and 121 long sides 111c, 112c, 113c, 114c, 119c, and 121c form one set of adjacent sides 125c and 125d as do the top short sides 111a, 112a, 113a, 114a, 119a, and 121a form 125e as seen in FIG. 6a. Each of the long sides 125c and 1125d are between about 20 to 40 inches in length and each of the back short sides round, oval or rectangular top and bottoms 111a, 112a, 111b, and 112b are between about 20 to 24 inches in width and the front short sides tops and bottoms 113a, 114a, 119a, 121a, 113b, 114b, 119b, and 121b are between about 10 and 12 inches in width.

Each of the long sides pattern pieces 11c, 112c, 113c, and 114c is permanently connected together forming seam 125c seen in FIG. 6a and pieces 111d, 112d, 119c and 121c is permanently connected together forming seam 125d as do short sides pattern pieces 11a, 112a, 113a, 114a, 119a, and 121a the long side pieces is connected together permanently.

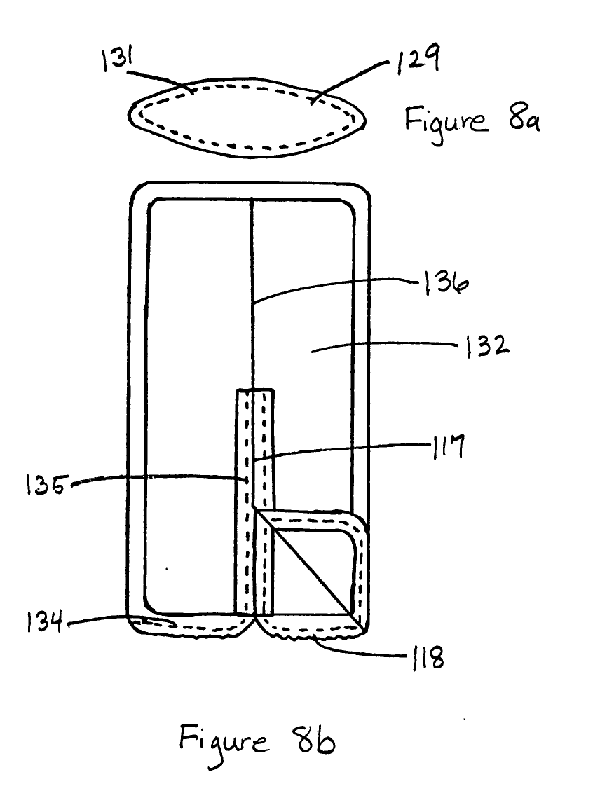

Each of the layers is disconnected from the other along one of short sides 123a from 122a on left and 124a on right which are both formed with marginal hems. Each hem is sewn or glued separately to the elastic band 118 which a fold was formed 118a along a line of stitching 134 as seen in FIGS. 6b and 8b after end pieces 111b and 118c of the elastic band is sewn or glued to pieces 122 and 124 at corner ends 122b and 124b are sewn or glued together as seen in FIGS. 6a and 8b permanently connected.

Each half side of the zipper, Velcro or snaps 117 is sewn or glued permanently to the bottom half of 122e and 124e top seam 126 is sewn together as seen in FIGS. 6a and 8b.

FIG. 6b By this arrangement, because of the width of the empty cavity 126 and free movement of the elastic band 118 space is provided for ease of insertion of particularly alternative nutrition/intravenous bags and poles.

I claim:

1. (canceled)

2. (canceled)

3. (canceled)

4. (canceled)

5. A pillowcase-like sack consisting of an open ended elastic band, integrated with an intravenous pole, sewn or glued closed top end of said pillowcase-like sack hangs over the top end of said intravenous pole, extending downward to conceal multiple intravenous fluid bags or alternative nutrition bags, while hanging from the said intravenous pole, consisting of two fabric, plastic, or paper components combinatorially sewn or glued together along adjacent side margins, sides of said intravenous fluid bags and said alternative nutrition bags are parallel to sides of said pillowcase-like sack, and said elastic band is hanging towards the floor.
